(19) United States
(12) Patent Application Publication
(10) Pub. No.: US 2013/0082170 A1
(43) Pub. Date: Apr. 4, 2013

(54) Density Derived From Spectra of Natural Radioactivity

(71) Applicant: Albert Alexseevich Fedorin, Novosibirsk (RU)

(72) Inventor: Mikhail A. Fedorin, Novosibirsk (RU)

(21) Appl. No.: 13/514,147

(22) PCT Filed: Jul. 4, 2011
(86) PCT No.: PCT/RU11/00481

§ 371 Date: Jun. 6, 2012

(51) Int. Cl. G01V 5/06

(52) U.S. Cl. CPC G01V 5/06
USPC 250/256

(57) ABSTRACT

The present disclosure relates to borehole logging methods and apparatuses for estimating a density of an earth formation using nuclear radiation, particularly by detecting naturally emitted gamma ray spectra. The method may include estimating a naturally emitted total gamma ray spectra; generating one or more simulated naturally emitted gamma ray spectra; and estimating the density of the earth formation using a comparison between the naturally emitted gamma ray spectra and at least one of the simulated naturally emitted gamma ray spectra. The apparatus may include at least one radiation detector configured to generate gamma information about an earth formation; and at least one processor configured to generate at least one simulated naturally emitted gamma ray spectra and to estimate the density of the earth formation using a comparison of the at least one naturally emitted gamma ray spectra with the at least one simulated naturally emitted gamma ray spectra.

### FIELD OF THE DISCLOSURE

This disclosure generally relates to borehole logging methods and apparatuses for estimating formation properties using nuclear radiation based measurements.

### BACKGROUND OF THE DISCLOSURE

Oil well logging has been known for many years and provides an oil and gas well driller with information about the particular earth formation being drilled. Hydrocarbons are generally contained in reservoirs formed in rock formations with various lithologies. The type of lithology may provide information as to the size and location of hydrocarbon containing reservoirs. Information regarding the type of lithology encountered during exploration and production may provide indications of the location and extent of hydrocarbons in a given earth formation.

Studies of the earth formations indicate the regular occurrence of naturally radioactive elements in various proportions depending on the type of lithology. Commonly, radioactive isotopes of potassium, uranium, and thorium are found in hydrocarbon bearing lithologies. A rigid or non-rigid carrier is often used to convey the nuclear radiation detectors, often as part of a tool or a set of tools, and the carrier may also provide communication channels for sending information up to the surface.

### SUMMARY OF THE DISCLOSURE

In aspects, the present disclosure is related to methods and apparatuses for estimating a density an earth formation using naturally emitted nuclear radiation estimates.

One embodiment according to the present disclosure includes a method of estimating a density of an earth formation, comprising: estimating the density of the earth formation using naturally emitted gamma ray spectra obtained by at least one radiation detector on a downhole tool in a borehole penetrating the earth formation.

Another embodiment according to the present disclosure includes an apparatus for estimating a density of an earth formation, comprising: a carrier configured to be conveyed in a borehole penetrating the earth formation; and at least one radiation detector disposed on the carrier and configured to produce a signal indicative of naturally emitted gamma ray spectra; and at least one processor configured to estimate the density of the earth formation using the signal produced by the at least one radiation detector.

Another embodiment according to the present disclosure includes a non-transitory computer-readable medium product having instructions thereon that, when executed, cause at least one processor to perform a method, the method comprising: estimating the density of the earth formation using naturally emitted gamma ray spectra obtained by at least one radiation detector on a downhole tool in a borehole penetrating the earth formation.

Examples of the more important features of the disclosure have been summarized rather broadly in order that the detailed description thereof that follows may be better understood and in order that the contributions they represent to the art may be appreciated.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1 shows a schematic of a downhole tool deployed in a borehole along a drill string according to one embodiment of the present disclosure;

FIG. 2 shows a schematic of a nuclear radiation detection module for one embodiment according to the present disclosure;

FIG. 3 shows a flow chart for a method for one embodiment according to the present disclosure;

FIG. 4 shows a chart with naturally emitted total gamma ray spectra for one embodiment according to the present disclosure; and

FIG. 5 shows a schematic of an apparatus for implementing one embodiment of the method according to the present disclosure.

### DETAILED DESCRIPTION

In aspects, this disclosure relates to estimating a density of an earth formation using naturally emitted nuclear radiation estimates.

Traditional spectrometric natural radioactivity tools may be used to determine a density of an earth formation. The natural radioactive decay of potassium, uranium, and thorium in an earth formation and borehole fluid may result in nuclear radiation. Herein, the term “nuclear radiation” includes particle and non-particle radiation emitted by atomic nuclei during nuclear processes (such as radioactive decay and/or nuclear bombardment), which may include, but are not limited to, photons, neutrons, electrons, alpha particles.

The amount of natural radioactive decay may be estimated based on Compton scattering in the earth formation using one or more nuclear radiation sensors disposed along a downhole tool. The lack of necessity of a radioactive source may reduce cost, risk, and time normally experienced when performing density analysis of the earth formation using a radioactive source.

The one or more nuclear radiation sensors may be configured to generate a signal indicative of the nuclear radiation detected. The detected nuclear radiation may include gamma rays. Since a gamma ray count may include gamma rays from radionuclides of multiple elements, the gamma ray count information may be separated into gamma ray components associated with each radionuclide. Herein, “information” may include raw data, processed data, analog signals, and digital signals.

A portion of the naturally emitted gamma ray spectra caused by scattered photons and having energies in the range 150-600 keV may be used to estimate bulk density of a formation. Some of the gamma photons may naturally occur in the 150-600 keV range (primary photons), and some of the gamma photons may occur at a higher energy level and scatter down to the 150-600 keV range due to interaction with atom in the earth formation and/or borehole fluid (secondary photons). Herein, the term “naturally emitted” refers to radiation that is emitted by a radionuclide without stimulation from outside the radionuclide, such as, but not limited to, neutron bombardment, and exposure to ionizing radiation.

Potassium, uranium, and thorium and the radionuclides in their prospective decay chains each have distinct gamma ray spectra, which may be used to estimate formation density. The concentrations of potassium, uranium and thorium (N_{K}, N_{U}, N_{Th}) can be estimated from the total gamma ray spectra N_{T}, by using a selected energy range. The total spectra are usually a linear combination of such spectra as shown in the following equation:

N_{T}=α_{K}N_{K}+α_{U}N_{U}+α_{Th}N_{Th} (1)

where α_{K}, α_{U} and α_{N} represent the contribution coefficients of the primary and secondary photons to the estimated total gamma ray spectra.

The contribution coefficients may be expressed as function of density, ρ, in terms of the primary and secondary photons as follows:

α_{K}(ρ)=α_{N}(ρ)+α_{K2}(ρ),

α_{U}(ρ)=α_{U1}(ρ)+α_{U2}(ρ), (2)

α_{Th}(ρ)=α_{Th1n}(ρ)+α_{Th2}(ρ)

where the subscript 1 indicates a primary photon contribution to the 150-600 keV range and the subscript 2 indicates a secondary photon contribution. Since potassium does not emit photons in the primary range, α_{K1}(ρ)=0.

A set of expected densities, ρₙ, may be used to generate simulated values for α_{K}(ρₙ),α_{U}(ρₙ),α_{Th}(ρₙ), from which simulated total gamma ray spectra N_{T}(ρₙ) may be generated as follows:

N_{T}(ρₙ)=α_{K}(ρₙ)N_{K}+α_{U}(ρₙ)N_{U}+α_{Th}(ρₙ)N_{Th};(n=1,2, . . . χ) (3)

The estimated total gamma ray spectra computed for the density window, N_{T}, may then be compared with one or more of the simulated total gamma ray spectra in the density window, N_{T}(ρₙ). An approximate match may be associated with a density, ρₙ, that will provide an estimated density, ρ, for the earth formation. In some embodiments, N_{T}(ρₙ) may be include modification due to one or more of: (i) tool configuration, (ii) borehole properties, and (iii) drilling/borehole fluid composition. In the event that N_{T} occurs between two N_{Tn} values, the density, ρ, may be estimated by interpolating between the two associated ρₙ values. A description for some embodiments estimating the at least one parameter of interest follows below.

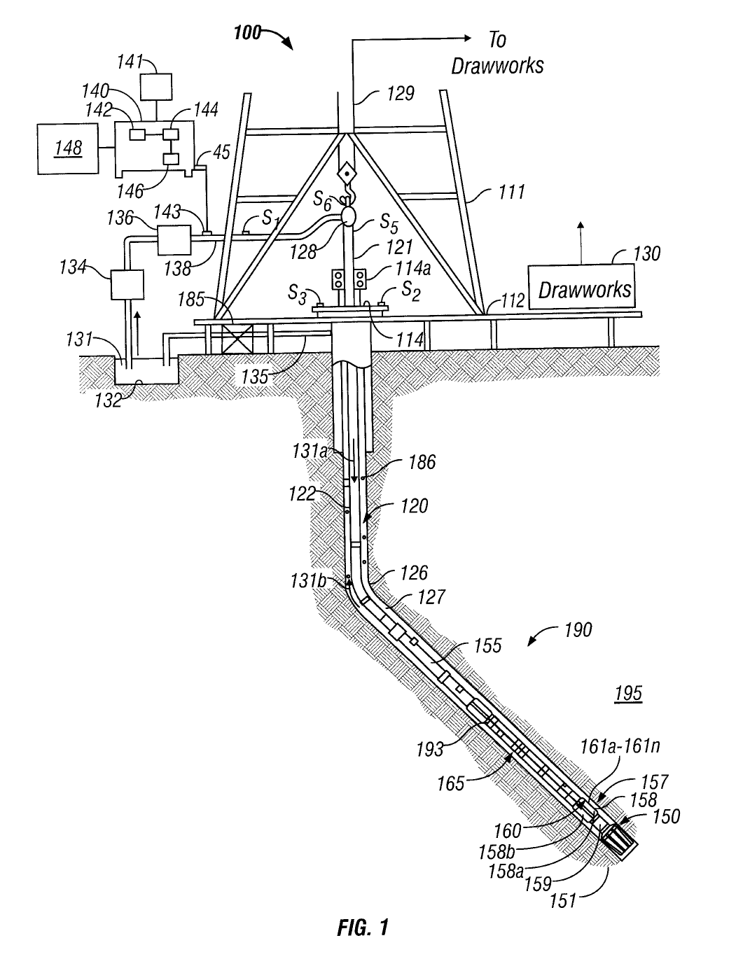

FIG. 1 is a schematic diagram of an exemplary drilling system 100 that includes a drill string having a drilling assembly attached to its bottom end that includes a steering unit according to one embodiment of the disclosure. FIG. 1 shows a drill string 120 that includes a drilling assembly or bottom hole assembly (BHA) 190 conveyed in a borehole 126. The drilling system 100 includes a conventional derrick 111 erected on a platform or floor 112 which supports a rotary table 114 that is rotated by a prime mover, such as an electric motor (not shown), at a desired rotational speed. A tubing (such as jointed drill pipe) 122, having the drilling assembly 190, attached at its bottom end extends from the surface to the bottom 151 of the borehole 126. A drill bit 150, attached to drilling assembly 190, disintegrates the geological formations when it is rotated to drill the borehole 126. The drill string 120 is coupled to a draw works 130 via a Kelly joint 121, swivel 128 and line 129 through a pulley. Draw works 130 is operated to control the weight on bit (“WOB”). The drill string 120 may be rotated by a top drive (not shown) instead of by the prime mover and the rotary table 114. Alternatively, a coiled-tubing may be used as the tubing 122. A tubing injector 114a may be used to convey the coiled-tubing having the drilling assembly attached to its bottom end. The operations of the draw works 130 and the tubing injector 114a are known in the art and are thus not described in detail herein.

A suitable drilling fluid 131 (also referred to as the “mud”) from a source 132 thereof, such as a mud pit, is circulated under pressure through the drill string 120 by a mud pump 134. The drilling fluid 131 passes from the mud pump 134 into the drill string 120 via a desurger 136 and the fluid line 138. The drilling fluid 131a from the drilling tubular discharges at the borehole bottom 151 through openings in the drill bit 150. The returning drilling fluid 131b circulates uphole through the annular space 127 between the drill string 120 and the borehole 126 and returns to the mud pit 132 via a return line 135 and drill cutting screen 185 that removes the drill cuttings 186 from the returning drilling fluid 131b. A sensor S₁ in line 138 provides information about the fluid flow rate. A surface torque sensor S₂ and a sensor S₃ associated with the drill string 120 respectively provide information about the torque and the rotational speed of the drill string 120. Tubing injection speed is determined from the sensor S₅, while the sensor S₆ provides the hook load of the drill string 120.

In some applications, the drill bit 150 is rotated by only rotating the drill pipe 122. However, in many other applications, a downhole motor 155 (mud motor) disposed in the drilling assembly 190 also rotates the drill bit 150. The rate of penetration (ROP) for a given BHA largely depends on the WOB or the thrust force on the drill bit 150 and its rotational speed.

The mud motor 155 is coupled to the drill bit 150 via a drive shaft disposed in a bearing assembly 157. The mud motor 155 rotates the drill bit 150 when the drilling fluid 131 passes through the mud motor 155 under pressure. The bearing assembly 157, in one aspect, supports the radial and axial forces of the drill bit 150, the down-thrust of the mud motor 155 and the reactive upward loading from the applied weight-on-bit.

A surface control unit or controller 140 receives signals from the downhole sensors and devices via a sensor 143 placed in the fluid line 138 and signals from sensors S₁-S₆ and other sensors used in the system 100 and processes such signals according to programmed instructions provided to the surface control unit 140. The surface control unit 140 displays desired drilling parameters and other information on a display/monitor 141 that is utilized by an operator to control the drilling operations. The surface control unit 140 may be a computer-based unit that may include a processor 142 (such as a microprocessor), a storage device 144, such as a solid-state memory, tape or hard disc, and one or more computer programs 146 in the storage device 144 that are accessible to the processor 142 for executing instructions contained in such programs. The surface control unit 140 may further communicate with a remote control unit 148. The surface control unit 140 may process data relating to the drilling operations, data from the sensors and devices on the surface, data received from downhole, and may control one or more operations of the downhole and surface devices. The data may be transmitted in analog or digital form.

The BHA 190 may also contain formation evaluation sensors or devices (also referred to as measurement-while-drilling (“MWD”) or logging-while-drilling (“LWD”) sensors) determining resistivity, density, porosity, permeability, acoustic properties, nuclear-magnetic resonance properties, formation pressures, properties or characteristics of the fluids downhole and other desired properties of the formation 195 surrounding the BHA 190. Such sensors are generally known in the art and for convenience are generally denoted herein by numeral 165. The BHA 190 may further include a variety of other sensors and devices 159 for determining one or more properties of the BHA 190 (such as vibration, bending moment, acceleration, oscillations, whirl, stick-slip, etc.) and drilling operating parameters, such as weight-on-bit, fluid flow rate, pressure, temperature, rate of penetration, azimuth, tool face, drill bit rotation, etc.) For convenience, all such sensors are denoted by numeral 159.

The BHA 190 may include a steering apparatus or tool 158 for steering the drill bit 150 along a desired drilling path. In one aspect, the steering apparatus may include a steering unit 160, having a number of force application members 161a-161n, wherein the steering unit is at partially integrated into the drilling motor. In another embodiment the steering apparatus may include a steering unit 158 having a bent sub and a first steering device 158a to orient the bent sub in the wellbore and the second steering device 158b to maintain the bent sub along a selected drilling direction.

The drilling system 100 may include sensors, circuitry and processing software and algorithms for providing information about desired dynamic drilling parameters relating to the BHA, drill string, the drill bit and downhole equipment such as a drilling motor, steering unit, thrusters, etc. Exemplary sensors include, but are not limited to drill bit sensors, an RPM sensor, a weight on bit sensor, sensors for measuring mud motor parameters (e.g., mud motor stator temperature, differential pressure across a mud motor, and fluid flow rate through a mud motor), and sensors for measuring acceleration, vibration, whirl, radial displacement, stick-slip, torque, shock, vibration, strain, stress, bending moment, bit bounce, axial thrust, friction, backward rotation, BHA buckling and radial thrust. Sensors distributed along the drill string can measure physical quantities such as drill string acceleration and strain, internal pressures in the drill string bore, external pressure in the annulus, vibration, temperature, electrical and magnetic field intensities inside the drill string, bore of the drill string, etc. Suitable systems for making dynamic downhole measurements include COPILOT, a downhole measurement system, manufactured by BAKER HUGHES INCORPORATED. Suitable systems are also discussed in “Downhole Diagnosis of Drilling Dynamics Data Provides New Level Drilling Process Control to Driller”, SPE 49206, by G. Heisig and J. D. Macpherson, 1998.

The drilling system 100 can include one or more downhole processors at a suitable location such as 193 on the BHA 190. The processor(s) can be a microprocessor that uses a computer program implemented on a suitable machine readable medium that enables the processor to perform the control and processing. The machine readable medium may include ROMs, EPROMs, EAROMs, EEPROMs, Flash Memories, RAMs, Hard Drives and/or Optical disks. Other equipment such as power and data buses, power supplies, and the like will be apparent to one skilled in the art. In one embodiment, the MWD system utilizes mud pulse telemetry to communicate data from a downhole location to the surface while drilling operations take place. The surface processor 142 can process the surface measured data, along with the data transmitted from the downhole processor, to evaluate formation lithology. While a drill string 120 is shown as a conveyance system for sensors 165, it should be understood that embodiments of the present disclosure may be used in connection with tools conveyed via rigid (e.g. jointed tubular or coiled tubing) as well as non-rigid (e. g. wireline, slickline, e-line, etc.) conveyance systems. The drilling system 100 may include a bottomhole assembly and/or sensors and equipment for implementation of embodiments of the present disclosure on either a drill string or a wireline. A point of novelty of the system illustrated in FIG. 1 is that the surface processor 142 and/or the downhole processor 193 are configured to perform certain methods (discussed below) that are not in prior art.

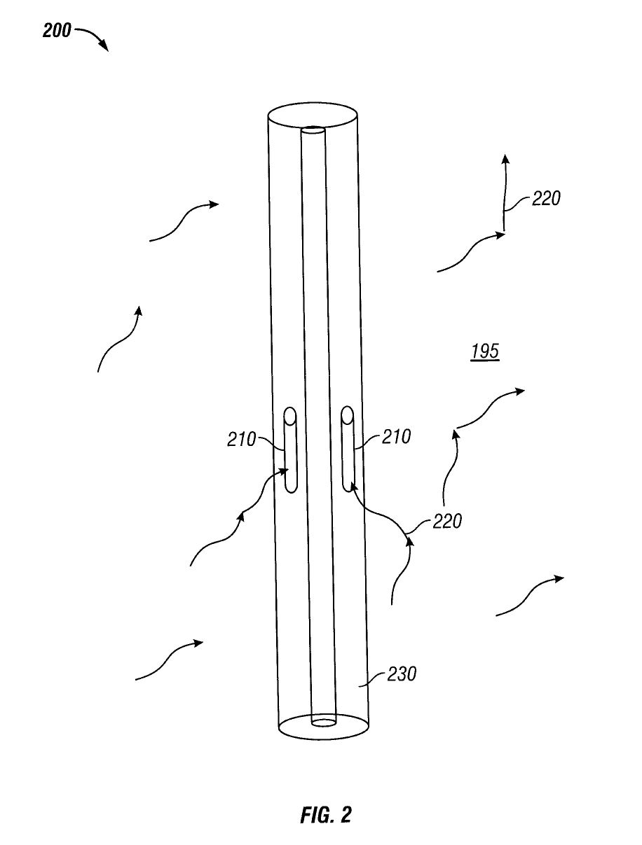

FIG. 2 shows a nuclear radiation detection module 200 that may be incorporated in BHA 190, such as along with evaluation sensors 165 according to one embodiment of the present disclosure. The nuclear radiation detection module 200 may include one or more sensors 210 configured to detect nuclear radiation emissions 220 from the earth formation 195. Nuclear radiation emissions 220 may be the result of gamma rays emitted by or scattering by earth formation 195. The depiction of the nuclear radiation detection module 200 having two radiation detectors 210 azimuthally separated at the same drilling depth is exemplary and illustrative only, as any number of radiation detectors may be used at one or more drilling depths on one or multiple sides of the nuclear radiation detection module 200.

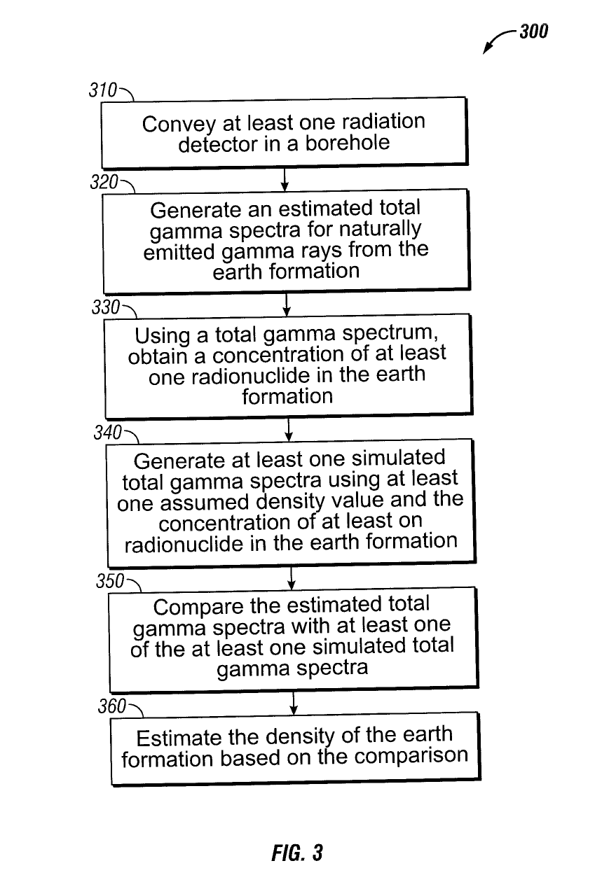

FIG. 3 shows a flow chart 300 for estimating a density of the earth formation 195 according to one embodiment of the present disclosure. In step 310, at least one radiation detector 210 may be conveyed into a borehole 126 penetrating the earth formation 195. The at least one radiation detector 210 may be configured to generate a signal in response to gamma radiation. In step 320, the at least one radiation detector 210 may generate a signal indicative of a total gamma ray spectra for naturally emitted gamma rays of the earth formation 195. The total gamma ray spectra may cover a range of photon energies. The range of photon energies may include a range of 150 keV-600 keV. In step 330, the concentration of at least one radionuclide in the earth formation 195 may be obtained using the signal indicative of the total gamma ray spectra. The at least one radionuclide may include one or more of: (i) thorium, (ii) uranium, and (iii) potassium. In step 340, at least one simulated total gamma ray spectra maybe generated using at least one assumed density value and the concentration of the at least one radionuclide in the earth formation 195. The at least one simulated total gamma ray spectra may be generated using primary and secondary photon contribution values that are functions of the at least one assumed density for the at least one radionuclide. In step 350, the estimated total gamma ray spectra may be compared with at least one of the at least one simulated total gamma ray spectra. In step 360, the density of the earth formation 195 may be estimated using the comparison. In some embodiments, the density estimation may include interpolating between two of the at least one simulated total gamma ray spectra.

The estimation of potassium, uranium, and thorium concentrations may include separating the estimated total gamma ray spectra into gamma ray contributions for each radionuclide. The gamma ray contributions may be determined using a separation technique known to those of skill in the art. The separation technique may include, but is not limited to, (i) a mathematical equation, (ii) an algorithm, (iii) a spectral deconvolution technique, (iv) a stripping technique, and (v) a window technique, or a combination thereof.

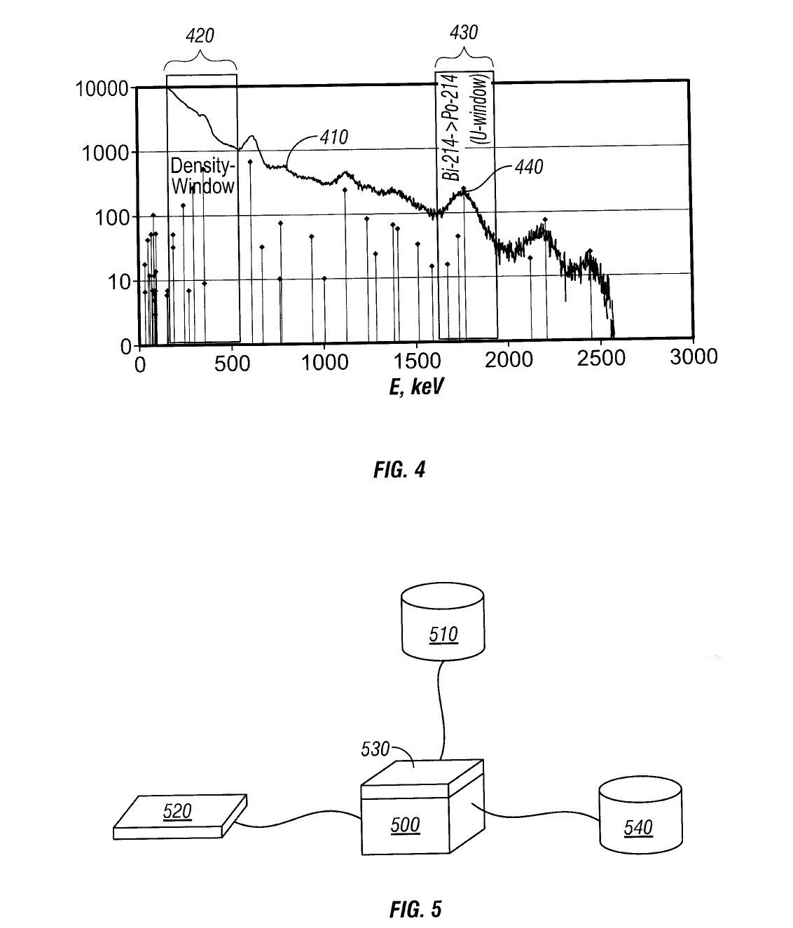

FIG. 4. shows a chart including estimated naturally emitted gamma ray spectra. The curve 410 represents the estimated naturally emitted total gamma ray spectra. A density window curve section 420 may indicate the energy range (150 keV-600 keV) that may be used to estimate the bulk density of the earth formation 195. A peak window 430 may be used for at least one separation technique, such as the windows technique, for estimating the concentration of a specific radionuclide that has a gamma ray emission signature in the range of the window 430. The peak 440 inside the window 430 may represent a gamma ray count increase associated with uranium.

As shown in FIG. 5, certain embodiments of the present disclosure may be implemented with a hardware environment that includes an information processor 500, a information storage medium 510, an input device 520, processor memory 530, and may include peripheral information storage medium 540. The hardware environment may be in the well, at the rig, or at a remote location. Moreover, the several components of the hardware environment may be distributed among those locations. The input device 520 may be any information reader or user input device, such as data card reader, keyboard, USB port, etc. The information storage medium 510 stores information provided by the detectors. Information storage medium 510 may be any standard computer information storage device, such as a ROM, USB drive, memory stick, hard disk, removable RAM, EPROMs, EAROMs, EEPROM, flash memories, and optical disks or other commonly used memory storage system known to one of ordinary skill in the art including Internet based storage. Information storage medium 510 stores a program that when executed causes information processor 500 to execute the disclosed method. Information storage medium 510 may also store the formation information provided by the user, or the formation information may be stored in a peripheral information storage medium 540, which may be any standard computer information storage device, such as a USB drive, memory stick, hard disk, removable RAM, or other commonly used memory storage system known to one of ordinary skill in the art including Internet based storage. Information processor 500 may be any form of computer or mathematical processing hardware, including Internet based hardware. When the program is loaded from information storage medium 510 into processor memory 530 (e.g. computer RAM), the program, when executed, causes information processor 500 to retrieve detector information from either information storage medium 510 or peripheral information storage medium 540 and process the information to estimate a parameter of interest. Information processor 500 may be located on the surface or downhole.

While the foregoing disclosure is directed to the one mode embodiments of the disclosure, various modifications will be apparent to those skilled in the art. It is intended that all variations be embraced by the foregoing disclosure.

1. A method of estimating a density of an earth formation, comprising:
estimating the density of the earth formation using naturally emitted gamma ray spectra obtained by at least one radiation detector on a downhole tool in a borehole penetrating the earth formation.

2. The method of claim 1, wherein estimating the density further comprises:
estimating a plurality of simulated naturally emitted gamma ray spectra for a set of assumed densities of the earth formation; and
comparing at least one of the plurality of simulated naturally emitted gamma ray spectra to the naturally emitted gamma ray spectra.

3. The method of claim 2, wherein the plurality of simulated naturally emitted gamma ray spectra are based on at least one radionuclide concentration of the earth formation and a configuration of the downhole tool.

4. The method of claim 3, further comprising:
obtaining the at least one radionuclide concentration.

5. The method of claim 4, wherein the at least one radionuclide concentration is obtained by separating the naturally emitted gamma ray spectra into a plurality of gamma ray spectra components.

6. The method of claim 5, wherein the separation is performed using a technique selected from the group consisting of: (i) spectral decomposition, (ii) a spectral windows method, and (iii) a combination of spectral decomposition and a spectral windows method.

7. The method of claim 3, wherein the at least one radionuclide concentration includes at least of: (i) a thorium concentration, (ii) a uranium concentration, and (iii) a potassium concentration.

8. The method of claim 2, further comprising:
forming the set of assumed densities, wherein each of the plurality of simulated naturally emitted gamma ray spectra is estimated using one of the set of assumed densities.

9. The method of claim 2, further comprising:
interpolating between two of the plurality of simulated naturally emitted gamma ray spectra to approximate the naturally emitted gamma ray spectra.

10. The method of claim 1, further comprising:
conveying the at least one radiation detector in the borehole.

11. An apparatus for estimating a density of an earth formation, comprising:
a carrier configured to be conveyed in a borehole penetrating the earth formation;
at least one radiation detector disposed on the carrier and configured to produce a signal indicative of naturally emitted gamma ray spectra; and
at least one processor configured to estimate the density of the earth formation using the signal produced by the at least one radiation detector.

12. The apparatus of claim 11, wherein the at least one processor is further configured to:
estimate the density by simulating a plurality of gamma ray spectra using at least one radionuclide concentration of the earth formation and a configuration of a downhole tool disposed on the carrier, wherein the at least one radiation detector is disposed in the downhole tool; and
compare at least one of the plurality of simulated naturally emitted gamma ray spectra to the naturally emitted gamma ray spectra.

13. The apparatus of claim 12, wherein the at least one processor is further configured to interpolate between two of the plurality of simulated naturally emitted gamma ray spectra to approximate the naturally emitted gamma ray spectra.

14. The apparatus of claim 12, wherein the at least one processor is further configured to estimate at least one radionuclide concentration from the naturally emitted gamma ray spectra using a technique selected from the group consisting of: (i) spectral decomposition, (ii) spectral windows, and (iii) a combination of spectral decomposition and spectral windows.

15. The apparatus of claim 12, wherein the at least one radionuclide concentration includes at least one of: (i) a thorium concentration, (ii) a uranium concentration, and (iii) a potassium concentration.

16. A non-transitory computer-readable medium product having instructions thereon that, when executed, cause at least one processor to perform a method, the method comprising:
estimating the density of the earth formation using naturally emitted gamma ray spectra obtained by at least one radiation detector on a downhole tool in a borehole penetrating the earth formation.

17. The non-transitory computer-readable medium product of claim 16 further comprising at least one of: (i) a ROM, (ii) an EPROM, (iii) an EEPROM, (iv) a flash memory, or (v) an optical disk.
